(19) United States
(12) Patent Application Publication
(10) Pub. No.: US 2018/0195392 A1
(43) Pub. Date: Jul. 12, 2018

(54) STEAM TURBINE SYSTEM WITH IMPULSE STAGE HAVING PLURALITY OF NOZZLE GROUPS

(71) Applicant: General Electric Company, Schenectady, NY (US)

(72) Inventors: Silvia Velm, Karlsruhe (DE); Felix Rene Boehm, Kirchheim (DE); Christoph Skomudek, Mannheim (DE)

(21) Appl. No.: 15/403,448

(22) Filed: Jan. 11, 2017

(51) Int. Cl. F01D 1/16; F01D 1/04; F01D 25/24

(52) U.S. Cl. CPC F01D 1/16; F01D 1/04; F05D 2220/31; F05D 2220/76; F01D 25/24

(57) ABSTRACT

A steam turbine system, including a plurality of blade stages arranged axially along a first shaft, an impulse stage configured upstream of the plurality of blade stages, the impulse stage having an impulse wheel and a casing, the casing including a plurality of inlet sections with each of the plurality of inlet sections having a corresponding nozzle group and operatively connected to a corresponding control valve controlling a first steam flow through the corresponding nozzle group, a first inlet configured to provide the first steam flow through the impulse stage and the plurality of blade stages, and, a second inlet configured to provide a second steam flow to the plurality of blade stages and bypassing the impulse stage.

### BACKGROUND OF THE INVENTION

The present disclosure relates generally to a turbomachine system, and more particularly, to a steam turbine system with an impulse stage having a plurality of nozzle groups individually controlled.

With the rise of renewable energies available, steam power plants operate in low or minimal load in order to react to fluctuations in the power generation of these renewable energies, such as solar and wind. However, steam power plants that operate in sliding pressure mode still have to maintain a certain fixed minimum pressure mode during part load in order to protect the boiler from overheating. State of the art steam power plants operating in sliding pressure mode maintain this fixed minimum pressure mode at low and minimum loads by throttling the live steam via the high pressure (HP) turbine entry valve. The lower the plant load, the higher the throttling losses and the lower the cycle efficiency.

### BRIEF DESCRIPTION OF THE INVENTION

A first aspect of the disclosure provides a steam turbine system including a plurality of blade stages arranged axially along a first shaft, an impulse stage configured upstream of the plurality of blade stages, the impulse stage having an impulse wheel and a casing, the casing including a plurality of inlet sections with each of the plurality of inlet sections having a corresponding nozzle group and operatively connected to a corresponding control valve controlling a first steam flow through the corresponding nozzle group, a first inlet configured to provide the first steam flow through the impulse stage and the plurality of blade stages, and, a second inlet configured to provide a second steam flow to the plurality of blade stages and bypassing the impulse stage.

A second aspect of the disclosure provides a power plant including a steam source for generating a steam flow, a high pressure turbine system having a plurality of blade stages arranged axially along a first shaft, an impulse stage configured upstream of the plurality of blade stages, the impulse stage having an impulse wheel and a casing, the casing including a plurality of inlet sections with each of the plurality of inlet sections having a corresponding nozzle group and operatively connected to a corresponding control valve controlling a first steam flow through the corresponding nozzle group, a first inlet configured to provide the first steam flow through the impulse stage and the plurality of blade stages, and, a second inlet configured to provide a second steam flow to the plurality of blade stages and bypassing the impulse stage, an intermediate turbine system and low pressure turbine system fluidly coupled to the high pressure turbine system, and, a first generator driven by the first shaft.

A third aspect of the disclosure provides an impulse stage system for a steam turbine system, the impulse stage system including an impulse wheel arranged on a first shaft, and, a casing including a plurality of inlet sections, wherein each of the plurality of inlet sections has a corresponding nozzle group and is operatively connected to a corresponding control valve controlling a first steam flow through the corresponding nozzle group, a first inlet configured to feed the first steam flow through the impulse stage.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a lengthwise cross-sectional view of a prior art steam turbine system.

FIG. 2 is a front view of an impulse stage casing according to embodiments of the disclosure.

FIG. 3 is a schematic cross-sectional view of an impulse stage according to embodiments of the disclosure.

FIG. 4 is a lengthwise cross-sectional view of a steam turbine system according to embodiments of the disclosure.

FIG. 5 is a schematic view of a steam turbine system according to embodiments of the disclosure.

FIG. 6 is a schematic view of a steam turbine system according to embodiments of the disclosure.

FIG. 7 is a schematic view of a steam turbine system according to embodiments of the disclosure.

FIG. 8 is a schematic view of a steam power plant system according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within a steam turbine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this inlet section. These terms and their definitions, unless stated otherwise, are as follows. As used herein, “downstream” and “upstream” are terms that indicate a direction relative to the flow of a fluid, such as the working fluid through the turbine engine or, for example, the flow of air through the combustor or coolant through one of the turbine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the engine, and “aft” referring to the rearward or turbine end of the engine. It is often required to describe parts that are at differing radial positions with regard to a center axis. The term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbine.

As used herein, “approximately” indicates+/−10% of the value, or if a range, of the values stated.

Typically, steam power plants generate power while operating in either a constant pressure mode or a sliding pressure mode. While operating in the constant pressure mode, steam turbine control valves are throttled in order to control the pressure of the steam at the steam turbine inlet. While operating a steam power plant in the sliding pressure mode, the control valves are maintained in a constant position, and the steam pressure is controlled by boiler control loops. State of the art steam power plants operating in sliding pressure mode maintain a minimum pressure at low and minimum loads by throttling the live steam via the HP turbine entry valve. Throttling is used to shed load by reducing the valve area. When steam passes through a narrow area, it acquires kinetic energy at the expense of heat (enthalpy). The expansion of the steam beyond the valve causes some of the generated kinetic energy to be converted to frictional heat. The result is the retention of some enthalpy, but a loss in pressure and an increase in entropy (loss in availability of energy). The pressure drop produced at the valves of the turbine inlet and all subsequent fixed blades restricts the mass flow through the turbine system and hence the power output. The lower the plant load, the higher the throttling losses and the lower the cycle efficiency.

In contrast to the state of the art where impulse wheels are used for fixed pressure steam power plants for the total range of load cases, embodiments of the present disclosure provide an impulse wheel used in sliding pressure power plants during low load and minimum load during fixed minimum pressure operation.

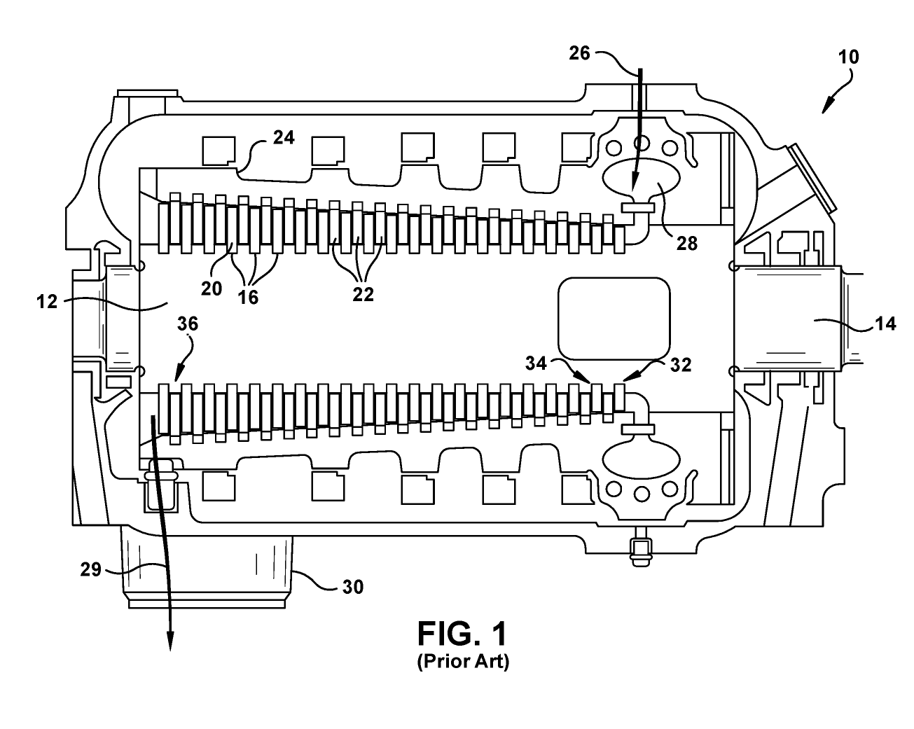

Referring to the drawings, FIG. 1 shows a lengthwise cross-sectional view of a prior art steam turbine system 10. Steam turbine system 10 includes a rotor 12 that includes a rotating shaft 14 and a plurality of axially spaced rotor wheels 16. A plurality of rotating blades 20 are mechanically coupled to each rotor wheel 16. More specifically, blades 20 are arranged in rows that extend circumferentially around each rotor 16. A plurality of stationary vanes 22 extends circumferentially around shaft 14 from stator 24, and the vanes are axially positioned between adjacent rows of blades 20. Stationary vanes 22 cooperate with blades 20 to form a stage and to define a portion of a steam flow path through turbine system 10.

In operation, steam 26 enters an inlet 28 of turbine 10 and is channeled through stationary vanes 22. Vanes 22 direct steam 26 downstream against blades 20. Steam 26 passes through the remaining stages imparting a force on blades 20 causing shaft 14 to rotate. At least one end of turbine system 10 may extend axially away from rotor 12 and may be attached to a load or machinery (not shown) such as, but not limited to, a generator, and/or another turbine. Steam 26 exits turbine 10 as exhaust 29 through outlet 30.

In FIG. 1, turbine system 10 comprises many blade stages. Stage 32 is the first blade stage and is the smallest (in a radial direction) of the blade stages. Stage 34 is the second stage and is the next stage in an axial direction downstream of first blade stage 32. Stage 36 is the last blade stage and is the largest (in a radial direction).

In general, embodiments of the present disclosure integrate an impulse stage with a high pressure (HP) turbine in order to reduce the resulting throttling losses during low load operation of a steam power plant. The impulse stage, in general, is configured upstream of the blade stages of the HP turbine and includes an impulse wheel and a casing having nozzle groups.

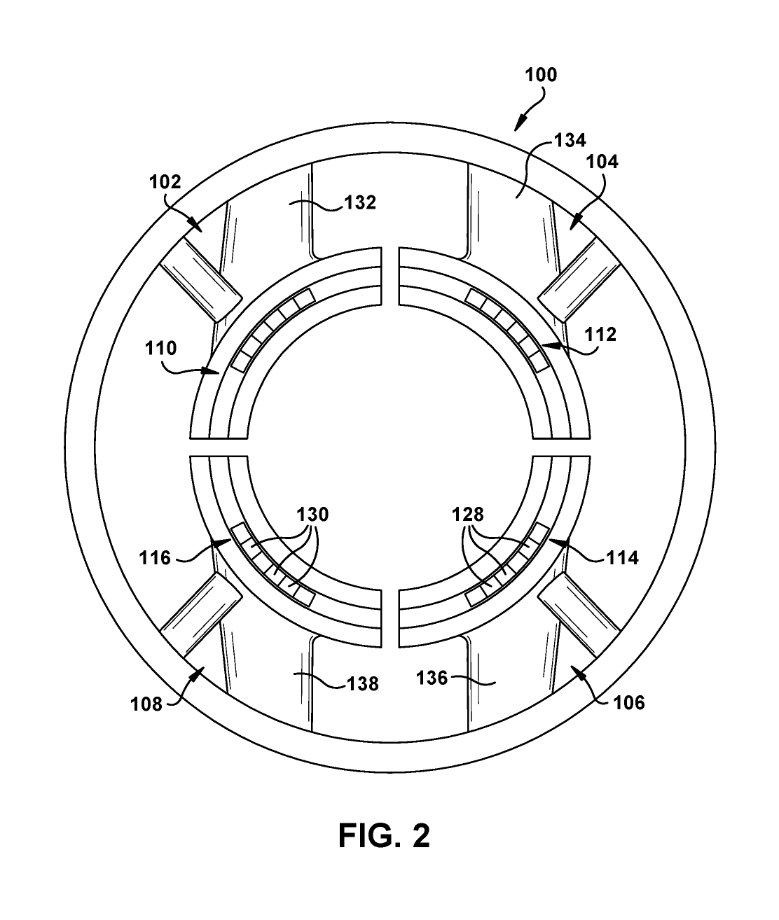

FIG. 2 is a front view of an exemplary embodiment of casing 100 for an exemplary impulse stage according to aspects of the disclosure. In the embodiment shown, casing 100 has four inlet sections 102, 104, 106, and 108. A person having ordinary skill in the art will recognize that embodiments according to the present disclosure can include two or more inlet sections within a casing and is not limited to the four inlet sections depicted in FIG. 2.

In the exemplary embodiment shown in FIG. 2, inlet sections 102, 104, 106, and 108 have corresponding nozzle groups 110, 112, 114, and 116, respectively. An impulse wheel (not shown) is configured co-axially in front of the corresponding nozzle groups such that, for example, a steam flow fed through inlet section 102 will exit casing 100 through corresponding nozzle group 110 and impinge upon the blades of the impulse wheel that are circumferentially proximate to nozzle group 110.

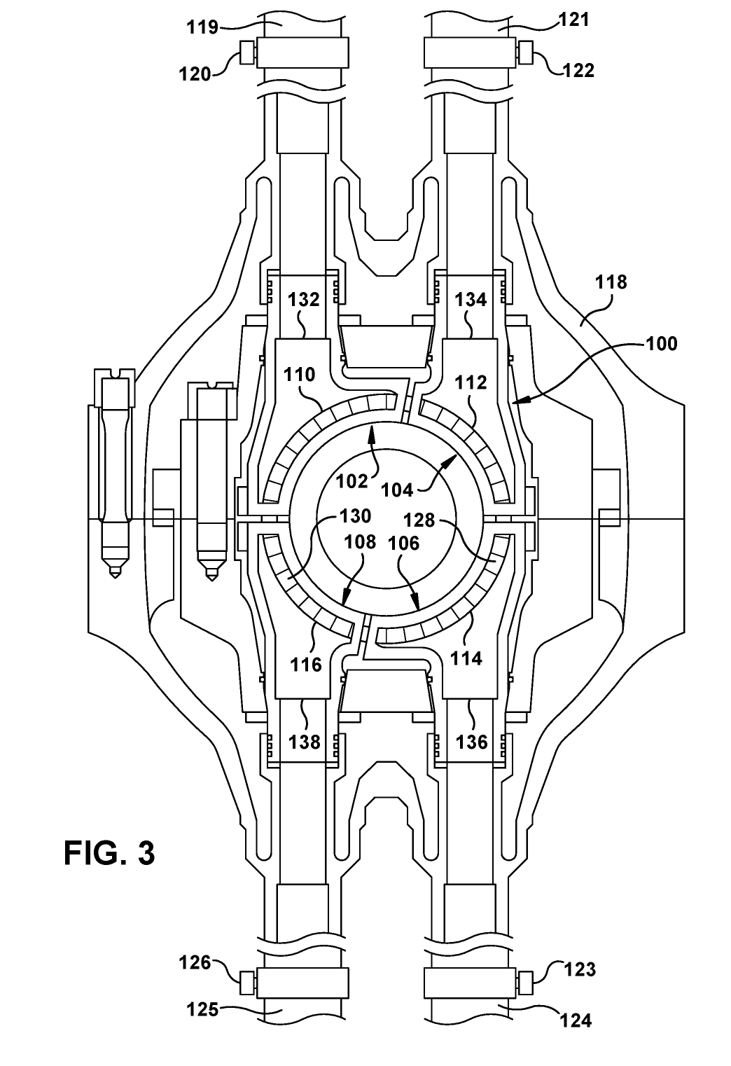

FIG. 3 is a cross-sectional view of casing 100 integrated into housing 118 of a steam turbine system. Casing 100 has inlet sections 102, 104, 106, and 108 with corresponding nozzle groups 110, 112, 114, and 116, respectively. Conduit 199 provides steam to inlet section 102 and includes control valve 120 to control the steam flow through section 102. Conduit 121 provides steam to inlet section 104 and includes control valve 122 to control the steam flow through section 104. Conduit 123 provides steam to inlet section 106 and includes control valve 124 to control the steam flow through section 106. Conduit 125 provides steam to inlet section 108 and includes control valve 126 to control the steam flow through section 108.

Nozzle groups 110, 112, 114 and 116 each may have a plurality of individual nozzles, e.g., nozzle 128 and nozzle 130. In an exemplary embodiment, each nozzle group 110, 112, 114, and 116, may have a different number of individual nozzles included in the nozzle group. For example, inlet section 102 may have nozzle group 110 with eight individual nozzles, while inlet section 104 may have nozzle group 112 with eleven individual nozzles. Further, in an exemplary embodiment, nozzle groups 110, 112, 114, and 116 may vary in the size of individual nozzles. For example, inlet section 108 may have nozzle group 116 with various individual nozzles 130 that may be larger than nozzles 128 in nozzle group 114 of inlet section 106.

Still referring to FIG. 3, inlet sections 102, 104, 106, and 108 of casing 100 have corresponding inlets 132, 134, 136, and 138, respectively. In operation, corresponding control valves 120, 122, 124, and 126, each control a steam flow through corresponding nozzle groups 110, 112, 114, and 116 by throttling at corresponding inlets 132, 134, 136, and 138. Corresponding control valves 120, 122, 124, and 126, are controlled by a control module (not shown) and can be throttled individually, which will be explained in more detail below.

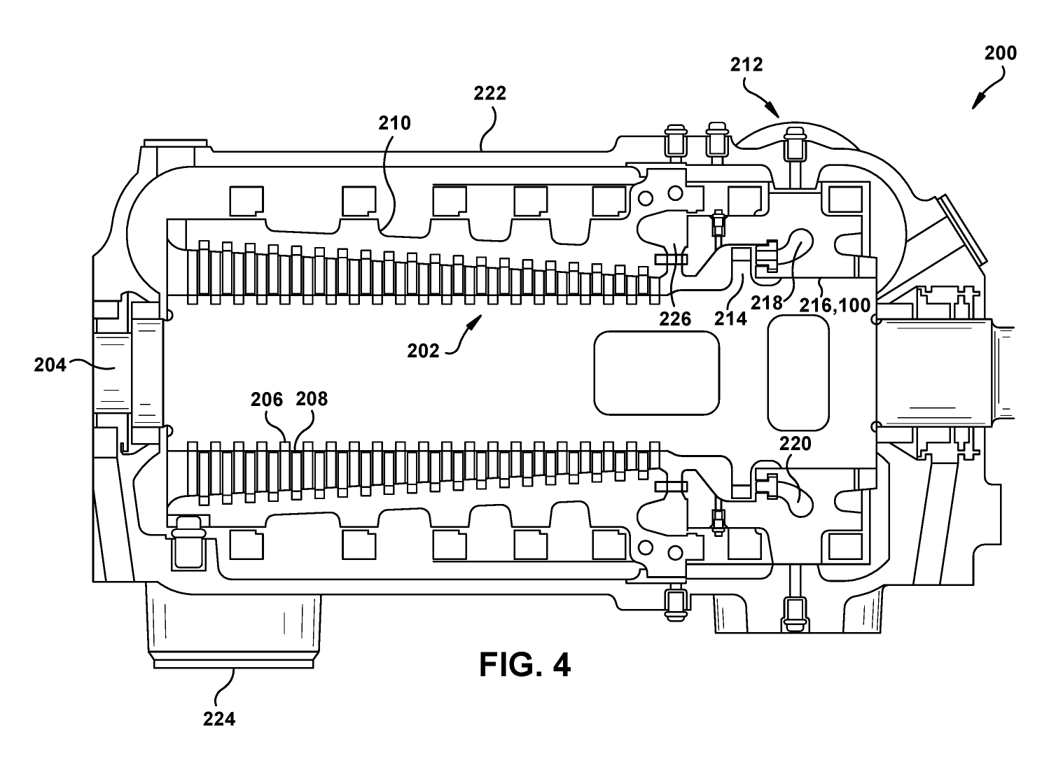

FIG. 4 is a lengthwise cross-sectional view of steam turbine system 200 according to embodiments of the present disclosure. System 200 includes a plurality of blade stages 202 arranged axially along a first shaft 204. In the exemplary embodiment shown, blade stages 202 are formed from rotor blades 206 mechanically coupled to first shaft 204 and cooperating with stationary vanes 208 mechanically coupled to stator 210. Impulse stage 212 is configured upstream in an axial direction of blade stages 202. Impulse stage 212 has impulse wheel 214 and casing 216 having a plurality of circumferentially spaced nozzle groups, of which only individual nozzles 218 and 220 can be seen. Casing 216 can be integrally formed with housing 222, or casing 216 can be a separate component, e.g., casing 100 and housing 118 as is shown in FIG. 3.

For clarity, the operation of steam turbine system 200 in FIG. 4 will be explained in an example embodiment where casing 216 of impulse stage 212 is casing 100 shown in FIG. 3. Referencing FIG. 3 and FIG. 4, in low load or minimum load operation, steam turbine system 200 can have a first steam flow provided through impulse stage 212 and the downstream blade stages 202 before exiting steam turbine system 200 via outlet 224. The path of the first steam flow through casing 100 is controlled by corresponding control valves 120, 122, 124, and 126 (labelled in FIG. 2). For example, if control valve 120 is open, then the first steam flow can enter inlet section 102 through inlet 132 and exit casing 100 via nozzle group 110. If control valve 124 is also open, then the first steam flow can enter inlet sections 102 and 106 through inlets 132 and 136, respectively, and exit casing 100 via nozzle groups 110 and 114, respectively. The first steam flow exits the nozzles of the desired nozzle groups and interacts with impulse wheel 214 before flowing through blade stages 202 and exits via outlet 224. Alternatively, steam turbine system 200 can have a second steam flow provided via inlet 226 wherein the steam flows through blade stages 202 and exits via outlet 224 while bypassing impulse stage 212.

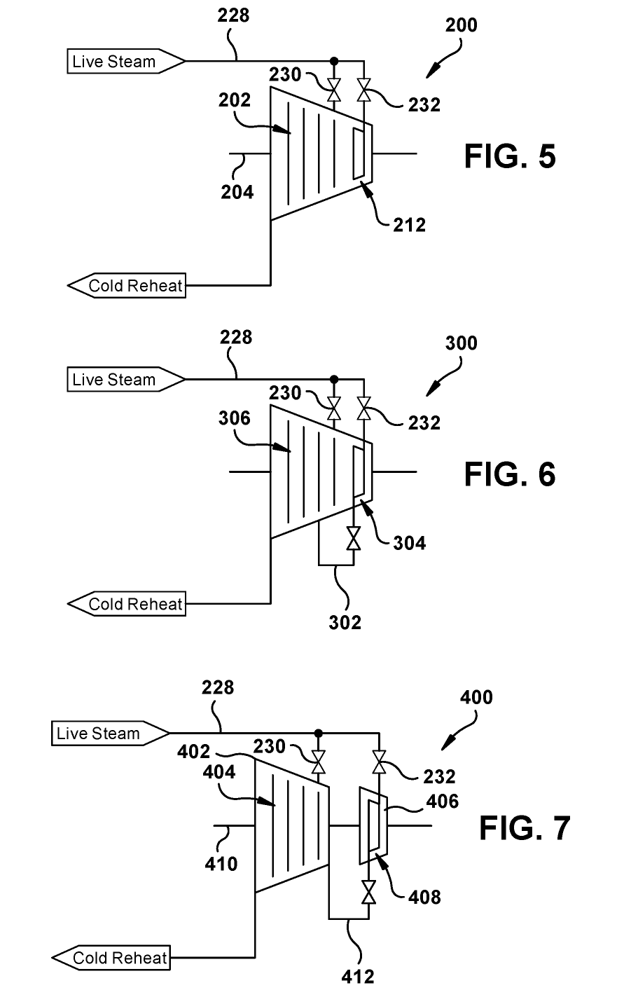

This is in contrast to state of the art steam power plants throttling the live steam via the main HP turbine control valve (what would be labelled as inlet 226 in FIG. 3, and as inlet 230 in FIGS. 5-7), which results in lower steam cycle efficiencies. Usually, the HP steam turbine also has several control valves. Instead, embodiments of the present disclosure provide an impulse wheel with a casing having nozzle groups that are in operation during the fixed minimum pressure mode while the main HP turbine control valves are closed. As such, the pressure drop at the HP turbine entry is transferred to mechanical energy at the impulse wheel by entering through the desired nozzle groups in embodiments of the present disclosure, increasing the steam cycle efficiency at low load.

Control valves 120, 122, 124 and 126 are controlled by a control module (not shown). In an embodiment, inlet sections 102, 104, 106, and 108 are designed such that all control valves 120, 122, 124 and 126 are open when the steam power plant load decreases to a load small enough that the minimum pressure mode should be maintained in order to protect the boiler. Usually, the fixed minimum pressure mode in sliding pressure power plants is maintained, e.g., starting at approximately 30-40% load. Further, in an embodiment, the inlet sections are designed such that only one of control valves 120, 122, 124 or 126 is fully open during minimum plant load operation. For the remaining decreasing load points between the start of maintaining the minimum pressure mode and the minimum plant load operation, the available control valves are opened or closed sequentially. As such, throttle losses can be reduced because control valves 120, 122, 124 and 126 are throttled one at a time.

In an embodiment, inlet sections 102, 104, 106, and 108 are designed such that diametrically opposing inlet sections have their corresponding control valves fully open during minimum plant load operation. For example: inlet section 102 having control valve 120 is diametrically opposed to inlet section 106 having control valve 124; and, inlet section 104 having control valve 122 is diametrically opposed to inlet section 108 having control valve 126.

Thus, in contrast to state of the art steam turbine systems, embodiments of the present disclosure throttle control valves 120, 122, 124 and 126 in the impulse stage inlets during fixed minimum pressure mode instead of throttling a valve controlling steam through inlet 226 (shown in FIG. 4). As such, throttle losses can be reduced because control valves 120, 122, 124 and 126 are throttled one at a time. The remaining pressure drop in the steam passing through control valves 120, 122, 124 and 126 is reduced in the nozzles of the corresponding nozzle groups 110, 112, 114, and 116, and the gained steam velocity is used to actuate the impulse wheel. With the inlet sections having different sized nozzles and nozzle numbers, the active turbine entry, and with this the swallowing capacity, can be adapted to the current volume flow.

FIG. 5 is a schematic view of steam turbine system 200 shown in FIG. 4. System 200 includes a plurality of blade stages 202 arranged axially along a first shaft 204. Impulse stage 212 is configured upstream of blade stages 202. In operation, feed line 228 provides an initial steam flow, e.g., from a boiler (not shown), and control valves 230 and 232 dictate where the steam flow enters system 200. For example, closing control valve 230 and opening control valve 232 causes feed line 228 to provide the first steam flow path through impulse stage 212 and the downstream blade stages 202, as was described above. Also, for example, closing control valve 232 and opening control valve 230 causes feed line 228 to provide the second steam flow path through blade stages while bypassing impulse stage 212, as was also described above.

FIG. 6 is a schematic view of exemplary steam turbine system 300 according to embodiments of the disclosure. System 300 may include bypass path 302 wherein the exhaust from impulse stage 304 bypasses one or several blade stages 306. In an example embodiment, nozzle groups of impulse stage 304 are configured to direct the steam flow to bypass at least one of the plurality of blade stages 306. System 300 is beneficial if the pressure drop over the first one or few blade stages 306 downstream of impulse stage 304 is not substantial enough to get the exhaust from impulse stage 304 to flow through system 300. In this case, bypass path 302 fluidly connects the exhaust of impulse stage 304 to a blade stage 306 where the pressure is lower than in the impulse stage. In an example embodiment, bypass path 302 is outside of the housing of the turbine system. System 300 is similar to system 200 in FIG. 5 in that feed line 228 provides an initial steam flow and control valves 230 and 232 dictate where the steam flow enters system 200.

FIG. 7 is a schematic view of exemplary steam turbine system 400 according to embodiments of the disclosure. System 400 includes first housing 402 enclosing blade stages 404, and second housing 406 enclosing impulse stage 408. Blade stages 404 and impulse stage 408 are arranged along shaft 410. Steam line 412 fluidly connects impulse stage 408 with blade stages 404. In an example embodiment, steam line 412 may bypass one or a few blade stages 404 similar to system 300 in FIG. 6. System 400 is similar to system 200 in FIG. 5 in that feed line 228 provides an initial steam flow and control valves 230 and 232 dictate where the steam flow enters system 400.

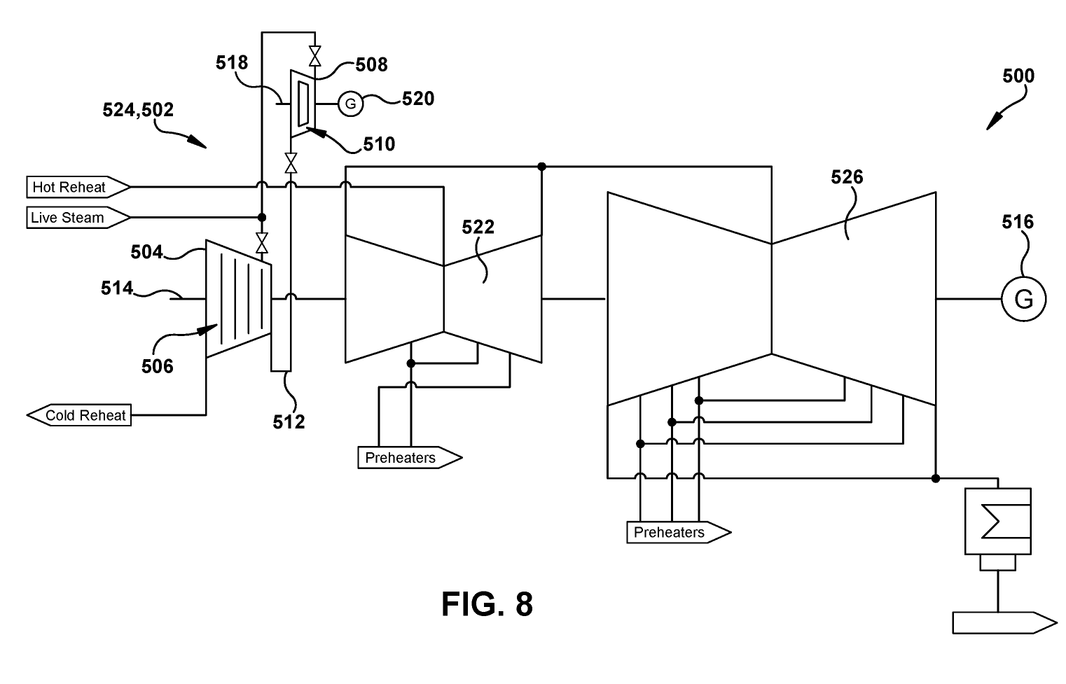

FIG. 8 is a schematic view of a part of a steam cycle power plant 500 according to embodiments of the disclosure. Plant 500 has steam turbine system 502. Steam turbine system 502 includes first housing 504 enclosing blade stages 506, and second housing 508 enclosing impulse stage 510. In an example embodiment, first housing 504 includes a first shaft, and second housing 508 includes a second shaft. Steam line 512 fluidly connects impulse stage 510 with blade stages 506. In an example embodiment, steam line 512 bypasses one or a few blade stages 506 similar to system 300 in FIG. 6. Steam turbine system 502 has blade stages 506 arranged along main shaft 514 coupled to main generator 516, and impulse stage arranged along a separate shaft 518 coupled to ancillary generator 520. The configuration of steam turbine system 502 is beneficial if there is not enough space to fit an impulse stage between first housing 504 enclosing blade stages 506 and intermediate pressure (IP), turbine 522. Steam turbine system 502 is similar to system 200 in FIG. 5 in that feed line 228 provides an initial steam flow and control valves 230 and 232 dictate where the steam flow enters system 502.

Plant 500 has steam turbine system 502 as HP turbine 524 that is fluidly coupled to IP turbine 522 and low pressure (LP) turbine 526 in a manner known in the art.

In example embodiments, HP turbine 524 of plant 500 may be any of steam turbine systems 200, 300, and 400 shown in FIG. 5, FIG. 6, and FIG. 7, respectively, instead of steam turbine system 502 as is shown in FIG. 8.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A steam turbine system, comprising:
a plurality of blade stages arranged axially along a first shaft;
an impulse stage configured upstream of the plurality of blade stages, the impulse stage having an impulse wheel and a casing, the casing including a plurality of inlet sections with each of the plurality of inlet sections having a corresponding nozzle group and operatively connected to a corresponding control valve controlling a first steam flow through the corresponding nozzle group;
a first inlet configured to provide the first stream flow through the impulse stage and the plurality of blade stages; and,
a second inlet configured to provide a second steam flow to the plurality of blade stages and bypassing the impulse stage.

2. The system of claim 1, wherein at least one of the plurality of nozzle groups has a different number of nozzles than the remaining nozzle groups.

3. The system of claim 1, wherein each of the nozzle groups of the impulse stage are configured to direct e first steam flow to bypass at least one of the plurality of blade stages.

4. The system of claim 1, further comprising a first housing enclosing the plurality of blade stages and the impulse stage.

5. The system of claim 1, further comprising a first housing enclosing the plurality of blade stages, and a second housing enclosing the impulse stage arranged on the first shaft.

6. The system of claim 1, further comprising a first housing enclosing the plurality of blade stages, and a second housing enclosing the impulse stage arranged on a second shaft.

7. A power plant, comprising:
a steam source for generating a steam flow;
a high pressure turbine system having:
a plurality of blade stages arranged axially along a first shaft;
an impulse stage configured upstream of the plurality of blade stages, the impulse stage having an impulse wheel and a casing, the casing including a plurality of inlet sections with each of the plurality of inlet sections having a corresponding nozzle group and operatively connected to a corresponding control valve controlling a first steam flow through the corresponding nozzle group;
a first inlet configured to provide the first steam flow through the impulse stage and the plurality of blade stages; and,
a second inlet configured to provide a second steam flow to the plurality of blade stages and bypassing the impulse stage;
an intermediate pressure turbine system and a low pressure turbine system fluidly coupled to the high pressure turbine system; and,
a first generator driven by the first shaft.

8. The power plant of claim 7, wherein at least one of the plurality of nozzle groups of the casing has a different number of nozzles than the remaining nozzle groups.

9. The power plant of claim 7, wherein each of the corresponding nozzle groups of the impulse stage are configured to direct the first steam flow to bypass at least one of the plurality of blade stages.

10. The power plant of claim 7, further comprising a first housing enclosing the plurality of blade stages and the impulse stage of the high pressure steam turbine system.

11. The power plant of claim 7, further comprising a first housing enclosing the plurality of blade stages, and a second housing enclosing the impulse stage arranged along the first shaft.

12. The power plant of claim 7, further comprising a first housing enclosing the plurality of blade stages, and a second housing enclosing the impulse stage arranged along a second shaft driving a second generator.

13. An impulse stage system for a steam turbine system, the impulse stage system comprising:
an impulse wheel arranged on a first shaft; and,
a casing including a plurality of inlet sections, wherein each of the plurality of inlet sections have a corresponding nozzle group and operatively connected to a corresponding control valve controlling a first steam flow through the corresponding nozzle group
a first inlet configured to feed the first steam flow through the impulse stage.

14. The system of claim 13, wherein at least one of the corresponding nozzle groups has a different number of nozzles than the remaining nozzle groups.
